(19) United States
(12) Patent Application Publication
(10) Pub. No.: US 2020/0357307 A1
(43) Pub. Date: Nov. 12, 2020

(54) A PACKAGE

(71) Applicant: Bemis Company, Inc., Neenah, WI (US)

(72) Inventor: Hibru K. MEBATSION, Greenville, WI (US)

(21) Appl. No.: 16/958,132

(22) PCT Filed: Dec. 29, 2017
(86) PCT No.: PCT/US2017/069040

§ 371 Date: Jun. 25, 2020

(51) Int. Cl. G09F 3/02; B32B 27/08; B32B 7/12; B65D 23/08

(52) U.S. Cl. CPC G09F 3/02; B32B 27/08; G09F 2003/0273; B65D 23/085; G09F 2003/0257; B32B 7/12

(57) ABSTRACT

The present disclosure relates to a package that includes a beverage bottle and a label that minimizes or eliminates flagging. The label can be transparent and includes a first film and a second film. The first film includes cast polypropylene. The second film includes oriented polypropylene. The first film and the second film are coterminous and are adhesively attached to each other. The density of the first film and the second film are substantially equal. The label includes a Modified Young's Modulus that is 30% less than a comparative label that does not include cast polypropylene.

### TECHNICAL FIELD

The present disclosure relates to a package that includes a beverage bottle and a label that minimizes or eliminates flagging.

### BACKGROUND OF THE DISCLOSURE

Labels are an aspect of packaging beverages within containers. Labels provide information including the ingredients and nutritional information. Labels can also provide graphics that may entice the consumer via decoration or brand recognition of the beverage contained therein. Additionally, consumers have indicated the desire to be able to see the container contents (beverage) through the label.

Beverages, for example, carbonated or non-carbonated beverages, can be packaged within containers such as transparent (e.g. clear) polyethylene terephthalate (PET) bottles that include a label. The label is applied by adhering the leading edge of the label to the bottle, wrapping the label around the bottle, and then overlaying and adhering the trailing edge to the leading edge creating a seal. A strong bond should be created between the label and the bottle as well as in the seal because beverage bottles are subject to pressure within the bottles changing over time; perhaps even more so for carbonated beverage bottles due to more pressurized gas within the beverage and thus the bottle. For example, environmental conditions such as high heat, or handling and jostling that can occur during shipping and transportation, can cause pressure within the bottle to increase, thus creating stress on the label. Increased stress on the label can cause the label to peel or become unattached from itself at the seal, which is referred to as flagging. Further, once the label has become unattached at the seal, there is a higher propensity for the label to become unattached from the bottle. Flagging leads to bottles that do not appeal to consumers or that can cause issues at the point of sale if the label is not attached to the bottle as intended.

Further, the physical properties of current transparent labels do not accommodate the internal pressure changes of the bottle. As such, flagging issues are prevalent with current beverage bottles, especially carbonated beverage bottles, which utilize transparent labels.

Past efforts to address flagging issues focused on increasing the surface adhesion of the labels by increasing the surface energy of the labels through embossing, chemical etching or UV radiation. US Patent Application Publication Number US 2016/0217712 discloses labels, transparent or opaque, that have increased surface energy for improved adhesion to the bottle and to itself. However, the problem of flagging continues to exist.

### SUMMARY OF THE DISCLOSURE

Thus, a need remains to minimize or eliminate the problem of flagging with packages that include a label and a beverage bottle that is subject to internal pressure changes.

In a first aspect, a package includes a beverage bottle and a label. The label includes a first film and a second film. The first film includes cast polypropylene and the label comprises a Modified Young's Modulus that is 30% less than a comparative transparent label that does not include cast polypropylene.

The label may include a Modified Young's Modulus greater than or equal to 300 ppi (5357 kilograms/meter).

The second film may include oriented polypropylene.

The label may be transparent and may include a clarity of at least 95%.

The bottle may include polyethylene terephthalate.

The first film of the label may be adhesively laminated to the second film.

The label may include graphics.

The first film and the second film may be coterminous with each other.

The first film and the second film may be adapted to remain attached to each other.

The label may further include a seal and the seal includes an adhesion strength of at least 4,000 grams force.

The density of the first film may be substantially similar to the density of the second film.

In another aspect, a package includes a beverage bottle and a label that includes a first film that includes cast polypropylene and a second film that includes oriented polypropylene. The first film is attached to the bottle and the label includes a seal positioned where the second film is attached to the first film after wrapping the label around the bottle.

The label may include a Modified Young's Modulus that is 30% less than a comparative transparent label that does not include cast polypropylene.

The label may include a Modified Young's Modulus greater than or equal to 300 ppi (5357 kilograms/meter).

The label may include a first film inner surface that may be permanently, adhesively attached to a second film inner surface.

The first film and the second film may be coterminous with each other.

The first film and the second film may be adapted to remain attached at the seal.

The seal may include an adhesion strength of at least 4,000 grams force.

In further aspect, a transparent label may include a first film that includes cast polypropylene, and

a second film that includes oriented polypropylene. The first film may be permanently, adhesively laminated to the second film. The first film may be coterminous with the second film. The label may include a Modified Young's Modulus greater than or equal to 300 ppi (5357 kilograms/meter). The label may include a Modified Young's Modulus that is 30% less than a comparative transparent label that does not include cast polypropylene. A seal of the first film and the second film may include an adhesion strength of at least 4,000 grams force.

These and other aspects of the disclosure are described in the detailed description below. In no event should the above summary be construed as a limitation on the claimed subject matter.

### BRIEF DESCRIPTION OF DRAWINGS

FIG. 1 representatively illustrates a perspective view of the package of the present disclosure.

FIG. 2 representatively illustrates a perspective view of the package of the present disclosure before the label is completely applied to the beverage bottle.

FIG. 3 representatively illustrates a cross-sectional view of the label along line 3-3 of FIG. 2.

Repeat use of reference characters in the present specification and drawings is intended to represent the same or analogous features or elements of the disclosure.

### DETAILED DESCRIPTION OF THE DISCLOSURE

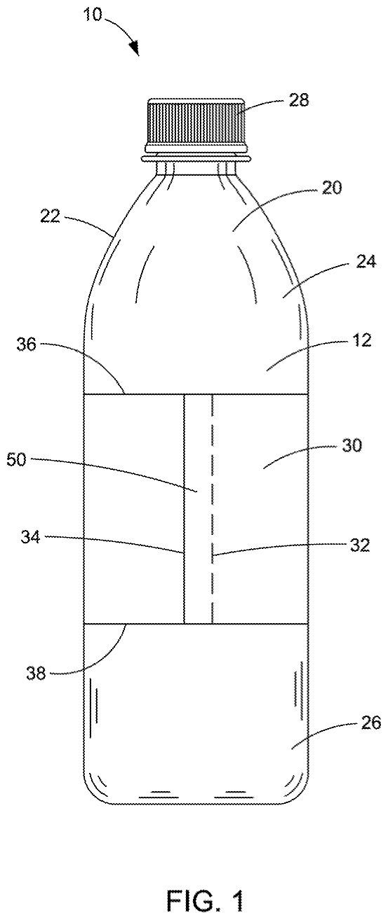

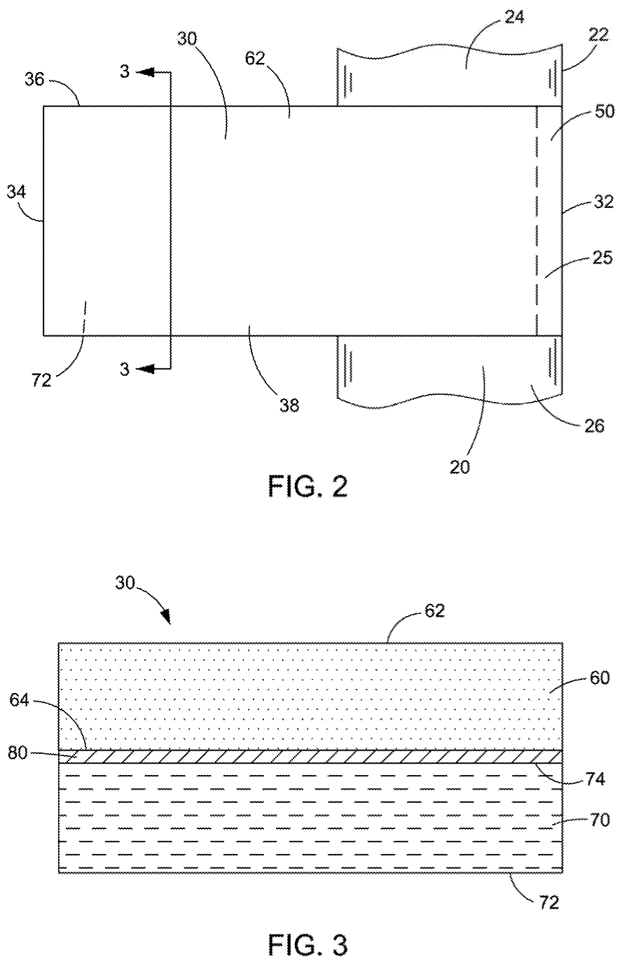

The present disclosure involves the control or reduction of flagging in a package 10 that includes a beverage bottle 20 and a label 30. Referring to FIGS. 1 and 2, a package 10 includes a beverage bottle 20, that is, a bottle or container that is adapted to contain a carbonated or non-carbonated beverage, and a label 30. The bottle 20 includes an outer surface 22 that includes an upper section 24 and a lower section 26, each connected to an intermediate section 25. The bottle 20 is generally cylindrical and can include a shaped upper section 24, a shaped lower section 26, a shaped intermediate section 25, or combinations thereof. The shape of the sections 24, 25, 26 may be determined for aesthetic or functional purposes, such as for example, to appeal to the consumer or to stably rest on a shelf. The bottle 20 can further include a cover 28 (e.g., cap, screw-top, etc.) that is removably attached to the upper section 24 of the bottle 20. The cover 28 acts as a closure to the bottle 20. For example, when the bottle 20 is filled with a beverage, the cover 28 ensures that the beverage remains contained therein. The bottle 20 can be made from any material known in the art for the purpose of containing beverages. A common material for bottles 20 having such purpose is polyethylene terephthalate (PET). PET bottles 20 are generally transparent. The terms “transparent”, “clear”, “see-through”, or “translucent” as used herein refers to a material or article (e.g., bottle, container, label, film, etc.) allowing light to pass through so that objects (e.g., contents, liquid, beverage, etc.) behind the material or article can be distinctly seen.

The label 30 in the embodiment shown in FIGS. 1 and 2 is shown to be generally rectangular and is also shown to be positioned in contact with the bottle 20 generally in the intermediate section 25. It should be understood that in other embodiments, the label 30 may be other than rectangularly shaped and that the label 30 may be positioned in the upper, intermediate, or lower sections, 24, 25, 26, of the bottle 20 or combinations thereof. The label 30 is shown to have a first edge 32, an opposing second edge 34 to the first edge 32, a third edge 36, and an opposing fourth edge 38 to the third edge 36. The label can be adhered to the outer surface 22 of the bottle 20 using adhesives (e.g., hot melt, etc.) in which the first edge 32 is adhered to the outer surface 22 and the label 20 is then wrapped around the bottle 20 such that the second edge 34 overlaps the first edge 32 and is adhered, creating a seal 50. It should be understood that in other embodiments, the label 30 can also be attached to the outer surface 22 of the bottle 20 such that portions of the label 30, other than the seal 50, can be attached to the outer surface 22 of the bottle 20. It should be further understood that in other embodiments, portions of the label 30 can be attached to itself, in areas other than the seal 50.

The label 30 of the present disclosure dynamically responds to the internal pressure changes that are experienced by the bottle 20; that is, the label 30 stretches with the bottle expansion and flagging is avoided or reduced. In this situation, the internal pressure of the bottle 20 is no longer concentrated at the seal 50 because the pressure can now be distributed on the label 30 due to the higher degree of stretchability of the label 30. Further, the label 30 can be transparent. Even with the addition of ink or graphics during conversion, the label 30 includes a high degree of transparency as opposed to opaque labels. Thus the disclosed label fills the unmet need for an anti-flagging, transparent label. Referring to FIG. 3, which is a cross section of the label 30 at line 3-3 shown in FIG. 2, the label 30 can be seen as a multi-layer structure that includes a first film 60 and a second film 70. The term “multi-layer” as used herein refers to a plurality of layers in a single structure generally in the form of a film, sheet or web which may be made from a polymeric material or a non-polymeric material bonded together by any conventional means known in the art (e.g., coextrusion, lamination, coating or blends of such). The label described in the present disclosure comprises as many layers as desired but at least two layers. The first film 60 includes a first outer surface 62 and a first inner surface 64. The second film 70 includes a second outer surface 72 and a second inner surface 74. The first film 60 and the second film 70 are laminated (e.g., connected, attached, etc.) to each other. In the embodiment shown in FIG. 3, the first inner surface 64 of the first film 60 is laminated to the second inner surface 74 of the second film 70 with adhesive layer 80. The adhesive layer 80 includes a first surface that interfaces with the first inner surface 64 and a second surface that interfaces with the second inner surface 74. The first film 60 is an oriented polypropylene film and the second film 70 is a non-oriented film, and more specifically, is a non-oriented, cast polypropylene film.

The term “oriented” as used herein refers to a film, sheet, web, etc., which has been elongated in at least one of the machine direction or the transverse direction. Such elongation is accomplished by procedures known in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving the tubular extrusion die is cooled, collapsed and then oriented by reheating, reinflating to form a secondary bubble, and recooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film (e.g., sheet, web, etc.). Upon subsequent heating of an unrestrained, unannealed, oriented article to its orientation temperature, heat-shrinkage (as measured in accordance with ASTM Test Method D2732, “Standard Test Method for Unrestrained Linear Thermal Shrinkage of Plastic Film and Sheeting”) may be produced. Heat-shrinkage may be reduced if the oriented article is first annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line (and in another process) from the orientation process.

The first film 60 is an oriented film and may be a single-layer film, a multi-layer film wherein the layers may be coextruded. The terms “coextruded” or “coextrusion” refer herein to the process of extruding two or more polymer materials through a single die with two or more orifices arranged so that the extrudates merge and weld together into a laminar structure before chilling (e.g., quenching). The multi-layer, coextruded, blown film is a thin film obtained by extruding raw materials of different proportions through a plurality of dies and laminating them together, and such a film can usually combine the performance advantages of all layers, such as good barrier performance, freshness preservation, moisture barrier performance, anti-frosting performance, oxygen barrier performance, oil resistance, and so on, so that it can be extensively used in various applications. In an embodiment, the first film 60 is a single-layer, oriented, film. In another embodiment, the first film 60 is a multi-layer, oriented, film including three coextruded layers.

The thickness of the first film 60, may be within a range of 0.4 mil-1.2 mil (10.2 μm-31.8 μm). In an embodiment of the present invention, the thickness of the blown film may be 0.40 mil-0.80 mil (10.2 μm-20.3 μm), such as 0.75 mil (19.0 μm), particularly 0.50 mil (12.7 μm), and preferably 0.48 mil (12.0 μm). In an embodiment, the thickness of the first film 60 can be 0.48 mil (12.0 μm). In another embodiment, the thickness of the first film 60 can be 0.75 mil (19.0 μm)

The first film 60, can be produced from any suitable material, for example, polypropylene, polyethylene, polyester, polyethylene-vinyl acetate, polyamide, poly(vinyl acetate), polyvinyl chloride, ethylene-vinyl alcohol copolymer, polyvinylidene chloride, polyvinyl fluoride, polystyrene, polylactic acid, etc. In an embodiment, the first film 60 is a single-layer, oriented film of polypropylene. In another embodiment, the first film 60 is a multi-layer, oriented film including three layers of coextruded polypropylene.

The second film 70 is a non-oriented, cast film. The term “cast film” as used herein, refers to an unstretched and non-oriented, flat, extruded, thin film that is manufactured by means of melt casting and quenching. The second film 70, may be a single-layer cast film or may be a multi-layer cast film. The single-layer cast film may be obtained by first plasticizing and melting raw materials by means of an extruder, and then extruding the molten polymer stream through a molding die (e.g., flat die, slot die) so as to cast the polymer stream onto a chilled roll and subsequently winding the film onto a core to form a roll for film for further processing. The multi-layer cast film may be obtained by laminating a plurality of single-layer cast films or by means of multi-layer, coextrusion casting (see “coextrusion” as described with reference to oriented film). The multi-layer, coextruded, cast film is further formed as described above for the single-layer cast film. In general, the multi-layer, co-extruded, cast film can include a wider range of selection of materials as compared with the single-layer film; for example, the materials that satisfy the requirements of individual layers may be selected individually, thus endowing the thin film with different functions and uses. The cast film includes good transparency, gloss, and uniform thickness. In an embodiment, the second film 70 is a single-layer cast film. In a further embodiment, the second film 70 is a multi-layer, coextruded, cast film including three layers.

The second film 70 may be manufactured, for example, by a solvent casting method or an extrusion casting method. The thickness of the second film 70, may be within a range of 0.5 mil-2.0 mil (12.7 μm-50.1 μm). In an embodiment of the present invention, the thickness of the second film 70 may be 0.60 mil-1.75 mil (15.2 μm-44.4 μm), such as 1.5 mil (38.1 μm), particularly 1.25 mil (31.8 μm), preferably 1.0 mil (25.4 μm). In an embodiment, the thickness of the second film 70 can be 1.0 mil (25.4 μm).

The second film 70 can be produced from any suitable material, for example, polypropylene, polyethylene, polyester, polyethylene-vinyl acetate, polyamide, polyvinyl chloride, ethylene-vinyl alcohol copolymer, polyvinylidene chloride, polyvinyl fluoride, polystyrene, polylactic acid, etc. In an embodiment, the second film 70 is a single-layer, cast, polypropylene film. In a further embodiment, the second film 70 is a multi-layer, co-extruded, cast, polypropylene film including three layers.

A method of preparing the label 30, includes a step of laminating the first inner surface 64 of the first film 60 to the second inner surface 74 of the second film 70 by an adhesive layer 80. The term “adhesive layer” 80, as used herein, refers to a material placed on the surface of one or more films, 60, 70, partially or entirely, to promote the adhesion of that film to another surface. Preferably, adhesive layers 80 or coatings are positioned between two films, 60, 70, of a multi-layer film to maintain the two film layers, 60 and 70, in position relative to each other and prevent undesirable delamination. Unless otherwise indicated, an adhesive layer 80 or coating can have any suitable composition that provides a desired level of adhesion with the one or more surfaces, for example, the surfaces 64 and 74, in contact with the adhesive layer 80 material. Optionally, an adhesive layer 80 or coating placed between a first film 60 and a second film 70 in a multi-layer film may comprise components of both the first film 60 and the second film 70 to promote simultaneous adhesion of the adhesive layer 80 to both the first film 60 and the second film 70 to opposite sides of the adhesive layer 80. Further, the first film 60 and/or the second film 70 may be printed on one of the surfaces, or combinations thereof, 62, 64, 72, 74 prior to or after lamination.

The label 30 can transparent (e.g., clear) except for the addition of ink. The label 30 may include graphics, lettering or indicia to convey information regarding the beverage contained within bottle 20, to provide decoration, or to provide brand recognition, among other things. In an embodiment, the first film 60 is a multi-layer, oriented polypropylene that is coextruded and reverse printed, as is known in the art, prior to lamination with second film 70. It should be understood that the first film 60 or the second film 70 can also be surface printed. A portion of the label 30 may not include graphics, lettering or indicia to allow visibility of the beverage contained within transparent bottle 20. It should be understood that due to the transparency of the label 30, the beverage contained within bottle 20 may still be visible in areas of the label 30 that include graphics, lettering or indicia. The inks used may be transparent or opaque. It should be further understood that the label 30 can be printed by a variety of methods as known to one skilled in the art, such as, gravure, flexo, digital, or hybrid flexo and digital. The addition of ink is insignificant to the overall thickness or to affect the physical properties of the label 30 as is known to one of skill in the art.

The label 30 can be prepared by laminating first film 60 and second film 70 by any suitable method, such as film extrusion lamination, adhesive bonding or others known in the art. The label 30 may be prepared by a method including the following steps, although the method of preparation is not limited thereby: uniformly coating an adhesive 80 on the first inner surface 64 of the first film 60 and/or the second inner surface 74 of the second film 70, and placing the inner surfaces, 64 and 74, facing each other, nipping the films 60 and 70 together, and curing the adhesive 80. In an embodiment, the first film 60 and the second film 70 may be laminated by a dry lamination process which is well-known to those skilled in the art, in which the specific steps may for example include coating an adhesive 80 on the surfaces, 64 and 74, of the first film 60 and the second film 70, driving off any solvent carrier, attaching the two surfaces, 64 and 74, together using pressure and heat, and then curing. In another embodiment, the first film 60 and the second film 70 may be laminated by a wet lamination process which is well-known to those skilled in the art, in which the specific steps may for example include coating an adhesive 80 on the surfaces, 64 and 74, of the first film 60 and/or the second film 70, attaching the two surfaces, 64 and 74, together and then curing.

The adhesive 80 is a permanent adhesive that is suitable for laminating the first film 60 and the second film 70 together and may be any adhesive commonly used in the art, such as a solvent adhesive or a solvent-free adhesive. The first film 60 and the second film 70 are not separable from each other with the permanent adhesive 80. The adhesive 80, for example, is not a temporary, pressure-sensitive (PSA) or non-permanent adhesive. Specific examples include vinyl acetate-ethylene copolymer adhesives, polyacrylate adhesives, polyurethane adhesives, epoxy resin adhesives, and the like. Polyurethane adhesives are particularly suitable for bonding a film layer to another film layer of, for example a oriented film and an cast film, or first film 60 and second film 70, having different properties. Suitable polyurethane adhesives include, but are not limited to, a water based polyurethane adhesive, a hot melt polyurethane adhesive, a solvent polyurethane adhesive, and a solvent-free polyurethane adhesive. The polyurethane adhesive may be either a single-component adhesive or a two-component adhesive. In an embodiment, the adhesive 80 is a water based, polyurethane adhesive. In an embodiment the adhesive may be applied at a dry weight of 0.5 to 1.5 lb/ream (0.815 g/m²-2.446 g/m²), 1.0 lb/ream (1.631 g/m²), or preferably 0.75 lb/ream (1.223 g/m²).

It should be understood that other methods of lamination may be appropriate for laminating the first film 60 to the second film 70, such as, extrusion lamination or non-adhesive methods, for example, thermal lamination, photodissociation, photolysis, etc., as is known in the art. Regardless of the lamination method, the first film 60 and the second film 70 of the label 30 are adapted to remain attached to each other to remain as a laminated, multi-layer structure. The first film 60 and the second film 70 are not intended to be separable or peeled apart prior to or after application of the label 30 to the beverage bottle 20.

In an embodiment, the first film 60 and the second film 70 are laminated to each other and then processed or slit such that the first film 60 and the second film 70 of the label 30 are coterminous with each other along the first edge 32, the second edge 34, the is third edge 36 and the fourth edge 38. Regardless of the shape of the label 30, the edges of each the first film 60 and the second film 70 are intended to be coterminous. The term “coterminous” as used herein refers to having the same or coincident boundaries. For example, the first film 60 and the second film 70 are connected to each other over the entire first inner surface 64 and second inner surface 74

With reference to FIG. 2, the label 30 can be applied by adhering, for example, the first edge 32 of the label 30 to the outer surface 22 of the bottle 20. In an embodiment, the second film 70 of the first edge 32 is adhered to the outer surface 22 of the bottle 20. The label 30 is then wrapped around the bottle 20 where the second film 70 of the second edge 34 of the label 30 is overlaid upon the first edge 32 of the first film 60 and the second edge 34 is adhered to the first film 60 creating a seal 50. It should be understood that the label can be applied in various manners.

In an embodiment, the label 30 of package 10 includes a first film 60 that is 48 gauge, hereinafter referred to as 48 g, (0.48 mil, 12 μm) transparent, oriented polypropylene (OPP) that is a three layer, coextruded polypropylene film available from Taghleef Industries, Rosedale, Ind., USA under the trade name of CTL 48. The second film 70 is 100 gauge (1.0 mil, 25.4 μm) transparent, cast polypropylene (CPP) that is a three layer, coextruded polypropylene film available from Copol International, North Sydney, N.S. Canada under the trade name of CP383X. The first film 60 and the second film 70 are laminated to each other with adhesive 80 that is a water based adhesive, Purethane™ A 1074, available from Ashland Inc., Covington, Ky., USA, at a dry coat weight of 0.5 to 0.75 lb/ream (0.815 gsm to 1.223 gsm). The first film 60 and the second film 70 are laminated to each other such that the first film 60 and the second film 70 are coterminous with each other over the inner surfaces 64 and 74. The label 30 does not include ink or graphics. The film structure of the label 30 of this embodiment, hereinafter referenced as Example 1, may be represented as:

48 g clear OPP/adhesive/100 g clear CPP

In another embodiment, the label 30 of package 10 includes a first film 60 that is 75 gauge, hereinafter referred to as 48 g, (0.75 mil, 19 μm) transparent, oriented polypropylene (OPP) that is a three layer, coextruded polypropylene film available from is Taghleef Industries, Rosedale, Ind., USA under the trade name of CTL 75. The second film 70 is 100 gauge (1.0 mil, 25.4 μm) cast polypropylene (CPP) that is a three layer, coextruded polypropylene film available from Copol International, North Sydney, N.S. Canada under the trade name of CP383X. The first film 60 and the second film 70 are laminated to each other with adhesive 80 that is a water based adhesive, Purethane™ A 1074, available from Ashland Inc., Covington, Ky., USA, at a dry coat weight of 0.5 to 0.75 lb/ream (0.815 gsm to 1.223 gsm). The first film 60 and the second film 70 are laminated to each other such that the first film 60 and the second film 70 are coterminous with each other over the inner surfaces 64 and 74. The label 30 did not include ink or graphics. The film structure of the label 30 of this embodiment, hereinafter referenced as Example 2, may be represented as:

75 g clear OPP/adhesive/100 g clear CPP

A commercial transparent label structure was also considered. The commercial transparent structure was: 75 g clear OPP/adhesive/75 g clear OPP available from Bemis Company, Inc., Neenah, Wis., USA. The adhesive used in the laminated film was Purethane™ A 1074 at a dry coat weight of 0.5 to 0.75 lb/ream (0.815 gsm to 1.223 gsm). This label film did not include ink or graphics. The film structure of this label is hereinafter referenced as Comparative Example 3.

A commercial opaque label structure was further considered. The commercial opaque structure was: 48 g clear OPP adhesive 110 white OPP available from Bemis Company, Inc., Neenah, Wis., USA. The adhesive used in the laminated film was Purethane™ A 1074 at dry coat weight of 0.5 to 0.75 lb/ream (0.815 g to 1.223 gsm). This label film did not include ink or graphics. The film structure of this label is hereinafter referenced as Comparative Example 4.

Physical characteristics of the first film 60, the second film 70, and the label 30 films, Examples 1 and 2, and Comparative Examples 3 and 4 are shown in Table 1. Data was collected with the following test methods or as noted below Table 1: ASTM D1003-13, ASTM D646-96 (2001), ASTM F2251-03 (2008), and ASTM D882-12.

TABLE 1

| | | | | | | | Young's |
|---|---|---|---|---|---|---|---|
| Sample and | Thickness | Density | Clarity | Haze | Tensile | Elongation | Modulus |
| Structure | (μm) | (g/cc) | (%) | (%) | (psi) | (%) | (psi) |
| 100 g CPP | 25.4 | 0.913 | 98.1 | 3.33 | 7,413 | 406 MD | 128,540 |
| | | | | | MD | 547 TD | MD |
| | | | | | 4,431 | | 134,916 |
| | | | | | TD | | TD |
| 48 g OPP | 12.0 | 0.903 | — | 1.5* | 22,162 | 103 MD | 374,423 |
| | | | | | MD | 50 TD | MD |
| | | | | | 38,594 | | 650,640 |
| | | | | | TD | | TD |
| 75 g OPP | 19.0 | 0.919 | — | 2.2* | 21,201 | 123 MD | 323,467 |
| | | | | | MD | 45 TD | MD |
| | | | | | 38,677 | | 645,216 |
| | | | | | TD | | TD |
| Example 1: | 41.6 | — | 95.1 | 3.16 | 7,933 | 120 MD | 189,409 |
| 48 g OPP/adh/ | | | | | MD | 43 TD | MD |
| 100 g CPP | | | | | 13,760 | | 262,369 |
| | | | | | TD | | TD |
| Example 2: | 44.9 | — | 96.0 | 3.56 | 9,462 | 108 MD | 182,784 |
| 75 g OPP/adh/ | | | | | MD | 53 TD | MD |
| 100 g CPP | | | | | 16,976 | | 289,161 |
| TD | | | | | TD | | |
| Comparative | 38.9 | — | — | — | 20,579 | 117 MD | 305,205 |
| Example 3: | | | | | MD | 51 TD | MD |
| 75 g dear | | | | | 35,679 | | 543,929 |
| OPP/adh/ | | | | | TD | | TD |
| 75 g dear OPP | | | | | | | |
| Comparative | 40.1 | — | — | — | 11,770 | 66 MD | 253,903 |
| Example 4: | | | | | MD | 27 TD | MD |
| 48 g dear | | | | | 20,162 | | 407,998 |
| OPP/adh/110 g | | | | | TD | | TD |
| white OPP | | | | | | | |

*Data reported from manufacturer's specification/product data sheet.
MD = machine direction
TD = transverse direction

The density difference between the first film 60 (CPP) and the second film 70 (OPP), at either thickness, is negligible. The a OPP films differ by 1% or less in density from the CPP.

The CPP has a clarity value of 98.1%. When CPP is laminated to either the 489 g OPP or the 75 g OPP, there is a drop in clarity to 95.1% and 96.0%, respectively. This results in a decrease of 3% and 2%, respectively. This implies that the CPP film is a more clear film than the OPP film. Without being bound by theory, as structure made of OPP film and OPP film would be less clear; that is, the current, commercial clear label, Comparative Example 3, would be less clear than Examples 1 and 2.

A more thorough comparison of the Young's Modulus (MD) for each label example (laminated film structure) was completed. To eliminate the effect of thickness of the label, the Young's Modulus (MD) for each example was multiplied by its thickness to arrive at the Modified Young's Modulus. The differences in Modified Young's Modulus between Example 1, Example 2, and Comparative Example 4 with respect to Comparative Example 3 are shown in Table 2.

TABLE 2

| | | | | | Modified |
|---|---|---|---|---|---|
| | | Young's | | Modified | Young's |
| | | Modulus | | Young's | Modulus |
| | | (psi) | Thickness | Modulus | Difference |
| Sample | Label Structure | MD | (mil) | (ppi) | (%) |
| Example 1 | 48 g OPP/adh/ | 189,409 | 1.64 | 310.63 | −33.48% |
| | 100 g CPP | | | | |
| Example 2 | 75 g OPP/adh/ | 182,784 | 1.77 | 323.53 | −30.72% |
| | 100 g CPP | | | | |
| Comparative | 75 g clear OPP/adh/ | 305,205 | 1.53 | 466.96 | 0.00% |
| Example 3 | 75 g clear OPP | | | | |
| Comparative | 48 g clear OPP/adh/ | 253,903 | 1.58 | 401.17 | −14.09% |
| Example 4 | 110 g white OPP | | | | |

The lower the Young's Modulus, the more extensible the material as is known in the art. It can be seen that the Modified Young's Modulus for Examples 1 and 2 are more than 30% lower than Comparative Example 3. The Modified Young's Modulus for Comparative Example 4 is 14% lower than Comparative Example 3. Comparative Example 4 labels experience little to no flagging issues when used on carbonated beverage bottles in the field. As such, it can be understood that the labels of Examples 1 and 2 would also experience little to no flagging issues when used on carbonated beverage bottles due to the low Young's modulus. Examples 1 and 2 are further transparent, additionally meeting the consumer need for clear labels.

The label 30 films of the present disclosure, Examples 1 and 2, were tested to simulate what might happen at the seal 50 in commercial applications. The seal 50 is formed when the first outer surface 62 of the first film 60, OPP, is adhered to the second outer surface 72 of the second film 70, CPP. Samples including the label 30 film of Example 1 were prepared using a Rock-Tenn commercial hot melt application simulator. MB1853 hot melt adhesive, available from H.B. Fuller, St. Paul, Minn., USA, was used with a coat weight of approximately 0.07 g per sample for the adhesion. Rock-Tenn hot melt simulator settings included those compatible with MB 1853. The methodology was replicated for Example 2 and Comparative Example 3. Adhesion results were gathered using ASTM F904-16 and are shown in Table 3.

TABLE 3

| | | Peak |
|---|---|---|
| | | Adhesion |
| | Structure | (grams force, gf) |
| Example 1 | 48 g OPP/adh/ | 4,255 ± 131 |
| | 100 g CPP | |
| Example 2 | 75 g OPP/adh/ | 4,090 ± 791 |
| | 100 g CPP | |
| Comparative | 75 g clear OPP/adh/ | 4,146 ± 317 |
| Example 3 | 75 g clear OPP | |

It can be seen that Examples 1 and 2 have adhesion values that are comparable to Comparative Example 3.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Many modifications and variations of the present disclosure can be made without departing from the spirit and scope thereof. Therefore, the exemplary embodiments described above should not be used to limit the scope of the invention.

Unless otherwise indicated, all numbers expressing quantities of ingredients, properties such as thickness, Young's modulus, clarity and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

What is claimed is:

1. A package comprising:
a beverage bottle, and
a label comprising a comprising a first film and a second film,
wherein the first film comprises cast polypropylene and wherein the label comprises a Modified Young's Modulus that is 30% less than a comparative transparent label that does not include cast polypropylene.

2. The package of claim 1 wherein the label further comprises a Modified Young's Modulus greater than or equal to 300 ppi (5357 kilograms/meter).

3. The package of claim 1 wherein the second film comprises oriented polypropylene.

4. The package of claim 1 wherein the label is transparent.

5. The package of claim 1 wherein the beverage bottle comprises polyethylene terephthalate.

6. The package of claim 4 wherein the transparent label comprises a clarity of at least 95%.

7. The package of claim 1 wherein the first film is adhesively laminated to the second film.

8. The package of claim 1 wherein the label further comprises graphics.

9. The package of claim 3 wherein the first film and the second film are coterminous with each other.

10. The package of claim 3 wherein the first film and the second film are adapted to remain attached to each other.

11. The package of claim 3 wherein the label further comprises a seal and the seal comprises an adhesion strength of at least 4,000 grams force.

12. The package of claim 3 wherein the density of the cast polypropylene is substantially similar to the density of the oriented polypropylene.

13. A package comprising:
a beverage bottle, and
a label comprising a first film comprising cast polypropylene and a second film comprising oriented polypropylene,
wherein the first film is attached to the bottle and wherein the label comprises a seal positioned where the second film is attached to the first film after wrapping the label around the bottle.

14. The package of claim 13 wherein the label further comprises a Modified Young's Modulus that is 30% less than a comparative transparent label that does not include cast polypropylene.

15. The package of claim 13 wherein the label further comprises a Modified Young's Modulus greater than or equal to 300 ppi (5357 kilograms/meter).

16. The package of claim 13 wherein a first film inner surface is permanently, adhesively attached to a second film inner surface.

17. The package of claim 13 wherein the first film and the second film are coterminous with each other.

18. The package of claim 16 wherein the first film and the second film are adapted to remain attached at the seal.

19. The package of claim 18 wherein the seal further comprises an adhesion strength of at least 4,000 grams force.

20. A transparent label comprising:
a first film comprising cast polypropylene, and
a second film comprising oriented polypropylene,
wherein the first film is permanently, adhesively laminated to the second film wherein the first film is coterminous with the second film, wherein the label comprises a Modified Young's Modulus greater than or equal to 300 ppi (5357 kilograms/meter), wherein the label comprises a Modified Young's Modulus that is 30% less than a comparative transparent label that does not include cast polypropylene, and wherein a seal of the first film and the second film comprises an adhesion strength of at least 4,000 grams force.
